(19) United States
(12) Patent Application Publication
(10) Pub. No.: US 2024/0097357 A1
(43) Pub. Date: Mar. 21, 2024

(54) ELECTRICAL CONTACT PADS WITH SURFACE DISCONTINUITIES AND POWER-RECEIVING UNITS AND ELECTRONIC DEVICES INCLUDING THE SAME

(71) Applicant: Altria Client Services LLC, Richmond, VA (US)

(72) Inventors: Yannick HOURMAND, Haslingfield (GB); Gary BROADFIELD, Stratford-upon-Avon (GB)

(73) Assignee: Altria Client Services LLC, Richmond, VA (US)

(21) Appl. No.: 18/053,149

(22) Filed: Nov. 7, 2022

Related U.S. Application Data
(60) Provisional application No. 63/407,932, filed on Sep. 19, 2022.

(51) Int. Cl. H01R 4/58

(52) U.S. Cl. CPC H01R 4/58

(57) ABSTRACT

An electrical contact pad includes a conductive component having at least one surface discontinuity configured to enhance an electrical connection therewith. A power-receiving unit may include a pair of the electrical contact pads. A power-supplying unit may include connector pins configured to engage with the at least one surface discontinuity of each of the pair of electrical contact pads so as to establish an electrical connection with the power-receiving unit.

### CROSS-REFERENCE TO RELATED APPLICATION

This application claims priority under 35 U.S.C. § 119 to U.S. Provisional Application No. 63/407,932, filed on Sep. 19, 2022, the entire contents of which are hereby incorporated by reference.

### BACKGROUND

### Field

The present disclosure relates to contact pads with modifications to surfaces thereof for enhanced electrical connectivity.

### Description of Related Art

A power-receiving unit may be configured to receive an electrical current from a power-supplying unit in order to perform a particular function. For instance, the power-receiving unit may have electrical contacts configured to engage with corresponding electrical contacts of the power-supplying unit so as to receive the electrical current. However, an electrical connection between the power-receiving unit and the power-supplying unit may be unstable and/or inconsistent.

### SUMMARY

At least one embodiment relates to an electrical contact pad (e.g., for a power-receiving unit). In an example embodiment, the electrical contact pad includes a conductive component including at least one surface discontinuity configured to enhance an electrical connection therewith.

In an example embodiment, the conductive component has a planar segment with the at least one surface discontinuity.

In an example embodiment, the at least one surface discontinuity includes one or more structurally-vulnerable portions configured to serve as focused points of contact during an establishment of the electrical connection.

In an example embodiment, the one or more structurally-vulnerable portions are configured to physically yield during the establishment of the electrical connection.

In an example embodiment, the at least one surface discontinuity includes one or more edges.

In an example embodiment, the at least one surface discontinuity includes a rim.

In an example embodiment, the at least one surface discontinuity is a machined portion of the conductive component that is configured to receive an electric current.

In an example embodiment, the at least one surface discontinuity is an opening in a surface of the section.

In an example embodiment, the opening is a recess.

In an example embodiment, the recess is a dimple.

In an example embodiment, the opening is a through hole in the conductive component.

In an example embodiment, the opening has a shape of a circle.

In an example embodiment, the circle has a diameter between 0.3 mm to 0.5 mm.

In an example embodiment, the at least one surface discontinuity is a chamfer on a surface of the conductive component.

At least one embodiment relates to a heater. In an example embodiment, the heater includes a first end section, an intermediate section, and a second end section. The first end section and the second end section each have at least one surface discontinuity configured to enhance an electrical connection therewith.

In an example embodiment, the at least one surface discontinuity includes one or more structurally-vulnerable portions configured to serve as focused points of contact during an establishment of the electrical connection.

At least one embodiment relates to a power-receiving unit. In an example embodiment, the power-receiving unit includes a pair of electrical contact pads each having at least one surface discontinuity configured to enhance an electrical connection therewith.

In an example embodiment, the pair of electrical contact pads are part of an exterior surface of the power-receiving unit.

At least one embodiment relates to an electronic device. In an example embodiment, the electronic device includes a power-receiving unit and a power-supplying unit. The power-receiving unit includes a pair of electrical contact pads each having at least one surface discontinuity. The power-supplying unit includes connector pins configured to engage with the at least one surface discontinuity of each of the pair of electrical contact pads so as to establish an electrical connection with the power-receiving unit.

In an example embodiment, the connector pins include voltage pins configured to engage with the at least one surface discontinuity of each of the pair of electrical contact pads.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a schematic, perspective view of the connector pins of a power-supplying unit and a power-receiving unit including a contact pad having at least one surface discontinuity configured for engagement with a corresponding one of the connector pins according to an example embodiment.

FIG. 2 is a schematic, plan view of the connector pins of a power-supplying unit as engaged with a contact pad of a power-receiving unit according to an example embodiment.

FIG. 3 is a schematic, plan view of the pin contact locations for a surface discontinuity of a contact pad of a power-receiving unit according to an example embodiment.

FIG. 4 is a schematic, cross-sectional view of a connector pin of a power-supplying unit as engaged with a surface discontinuity of a contact pad of a power-receiving unit according to an example embodiment.

FIG. 5 is a schematic, cross-sectional view of a connector pin of a power-supplying unit as engaged with a surface discontinuity of a contact pad of a power-receiving unit according to another example embodiment.

FIG. 6 is a schematic, perspective view of a connector pin of a power-supplying unit configured for engagement with a surface discontinuity of a contact pad of a power-receiving unit according to an example embodiment.

FIG. 7 is an isolated view of a heater with end sections as contact pads having at least one surface discontinuity according to an example embodiment.

FIG. 8 is an isolated view of a heater with end sections as contact pads having at least one surface discontinuity according to another example embodiment.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, component, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” specify the presence of stated features, integers, steps, operations, and/or elements, but do not preclude the presence or addition of one or more other features, integers, steps, operations, elements, and/or groups thereof.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As used herein, “coupled” includes both removably coupled and permanently coupled. For example, when an elastic layer and a support layer are removably coupled to one another, the elastic layer and the support layer can be separated upon the application of sufficient force.

In some example embodiments, the electrical contact pads of a power-receiving unit may become coated with an oxide layer. Such an oxide layer may occur naturally when certain metals are exposed to oxygen in the atmosphere. For instance, aluminum is reactive with the oxygen in the atmosphere and, as a result, has a naturally-occurring aluminum oxide layer on all oxygen-exposed surfaces of the aluminum. In another instance, stainless steel (e.g., 316 stainless steel) contains, inter alia, chromium, which is reactive with the oxygen in the atmosphere and, as a result, has a naturally-occurring chromium oxide layer on all oxygen-exposed surfaces of the stainless steel.

While a metal oxide layer may serve as a protective layer (e.g., corrosion resistance) for the underlying metal, the metal oxide layer is also an electrical insulator and, thus, may hinder the transmission of an electrical current. In particular, the presence of a metal oxide layer on the electrical contact pads of a power-receiving unit may interfere with the quality and consistency of an electrical connection with the connector elements (e.g., connector pins) of the power-supplying unit.

To mitigate/address the electrically-insulating effect of the metal oxide layer, an electrical contact arrangement may be configured such that an associated force between the engaging structures is focused on a relatively small surface area so as to increase the likelihood of penetrating (e.g., mechanically and/or electrically) the metal oxide layer and thereby improving the quality and consistency of an electrical connection with the underlying metal. In an example embodiment, an electrical contact pad may be fabricated/modified to introduce at least one surface discontinuity which provides for one or more focused points of contact (e.g., edge(s)) with a corresponding connector when electrically engaged. As used herein, a surface discontinuity should be understood to be disruption in an otherwise smooth and continuous surface. The surface discontinuity (or each of the surface discontinuities) may occupy a contiguous area of about 0.2 mm 2-0.80 mm² (e.g., 0.4 mm 2-0.6 mm²).

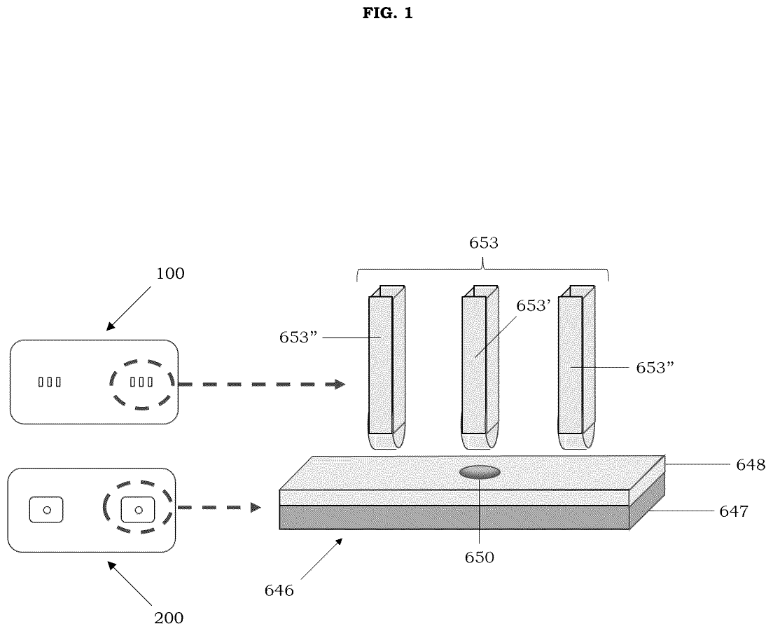

FIG. 1 is a schematic, perspective view of the connector pins of a power-supplying unit and a power-receiving unit including a contact pad having at least one surface discontinuity configured for engagement with a corresponding one of the connector pins according to an example embodiment. Referring to FIG. 1, a power-supplying unit 100 may include a power source and/or control circuitry which are in electrical communication with connector pins 653. The power source may include one or more batteries, capacitors, and the like. The connector pins 653 of the power-supplying unit 100 may be configured to transmit current as electrical energy and/or as an electrical signal to corresponding contact pads 646 of a power-receiving unit 200. The connector pins 653 may be formed of copper or of a copper alloy (e.g., copper-titanium) with the option of also being gold-plated. The contact pads 646 may be part of an exterior surface of the power-receiving unit 200, although example embodiments are not limited thereto. To enhance an engagement with the contact pad 646, the connector pins 653 may be spring-loaded or otherwise biased so as to resiliently press against the contact pad 646 when the power-supplying unit 100 is connected with the power-receiving unit 200. The combination of the power-supplying unit 100 and the power-receiving unit 200 may be referred to generally as an electronic device.

Although the connector pins 653 are shown as each set including three pins, it should be understood that example embodiments are not limited thereto. Specifically, in other instances, the connector pins 653 may include more (e.g., 4 pins per set) or less (e.g., 1-2 pins per set) than the set of three pins shown in the drawings. Additionally, while the connector pins 653 are shown as a set including a voltage pin 653′ between two current pins 653″, it should be understood that other quantities and combinations are possible. Furthermore, while the connector pins 653 and the contact pad 646 are shown as being a part of the power-supplying unit 100 and the power-receiving unit 200, respectively, it should be understood that, in some instances, this configuration may be reversed such that the connector pins 653 and the contact pad 646 are part of the power-receiving unit 200 and the power-supplying unit 100, respectively.

The contact pad 646 may be formed of various conductive materials that are suitable for establishing an electrical connection with the connector pins 653. In particular, the contact pad 646 may be formed of a metal with its outer surface coated with a naturally-occurring oxide of the metal. For instance, the contact pad 646 may be formed of stainless steel, and the chromium in the stainless steel may form a natural layer of chromium oxide on the stainless steel. In such an instance, the contact pad 646 may be regarded as having a base layer/material 647 of stainless steel and an outer/surface layer 648 of chromium oxide. In FIG. 1, it should be understood that the thickness of the outer layer 648 of naturally-occurring oxide has been exaggerated to better illustrate its presence. In actuality, the outer layer 648 of naturally-occurring oxide is relatively thin and may be in the order of several nanometers (e.g., 1-3 nm).

The contact pad 646 may be provided with a surface discontinuity 650 (or a plurality of surface discontinuities 650) to enhance the electrical connection between at least one of the connector pins 653 and the contact pad 646. In an example embodiment, the surface discontinuity 650 may be in the form of at least one opening in the surface of the contact pad 646. The opening may have a circular shape, although other shapes may also be utilized (e.g., oval, square, rectangle, diamond, slot). The opening may be provided as a recess/indentation (e.g., dimple) in the contact pad 646. Alternatively, the opening may be provided as a through hole that completely penetrates the contact pad 646. With regard to manufacturing, the contact pad 646 may be punched, stamped, drilled, etched, or otherwise machined before the assembly of the power-receiving unit 200 in order to achieve one or more openings as the surface discontinuity 650. Alternatively, techniques such as drilling may be performed after the assembly of the power-receiving unit 200. As a result of the surface discontinuity 650 in the contact pad 646, a mechanically-vulnerable (e.g., structurally-vulnerable) portion is provided via the rim/edge of the opening which increases the likelihood that a corresponding connector pin 653 will physically pierce, compromise, or otherwise break through this relatively weak point/portion in the outer oxide layer so as to establish a secure and consistent electrical connection with the underlying metal of the contact pad 646.

In FIG. 1, the connector pins 653 (which are part of the power-supplying unit 100) are illustrated as being above the contact pad 646 (which is part of the power-receiving unit 200). However, it should be understood that the relative positions of the connector pins 653 and the contact pad 646 may be different (e.g., reversed) depending on the orientation of the electronic device. For instance, when the electronic device is oriented in an upright position, the connector pins 653 of the power-supplying unit 100 may be below the contact pads 646 of the power-receiving unit 200. Furthermore, while only one opening in the surface of the contact pad 646 for the middle connector pin 653 has been shown, it should be understood that additional openings may also be provided with respect to one or both of the other connector pins 653.

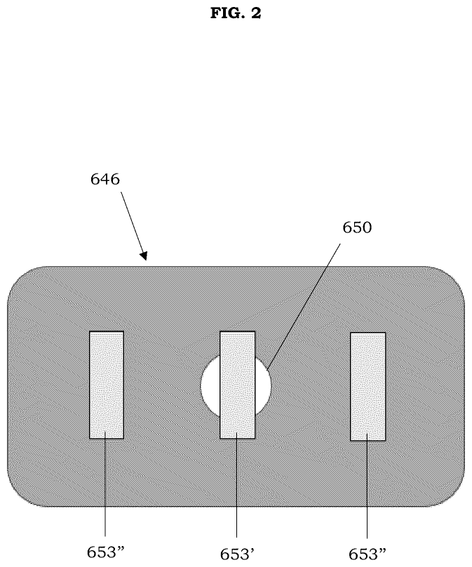

FIG. 2 is a schematic, plan view of the connector pins of a power-supplying unit as engaged with a contact pad of a power-receiving unit according to an example embodiment. Referring to FIG. 2, the connector pins 653 include a voltage pin 653′ engaged with a surface discontinuity 650 which has been provided as an opening (e.g., recess/hole) in a contact pad 646. The opening may have a circular shape with a diameter of about 0.3-0.5 mm (e.g., 0.4 mm). The voltage pin 653′ may be sized such that the corners (e.g., cross-sectional corners) of its tip are engaged with the rim/edge of the surface discontinuity 650. In a non-limiting embodiment, the voltage pin 653′ (as well as the current pins 653″) is wider than the opening provided as the surface discontinuity 650 in the contact pad 646. The connector pins 653 may also have a tapered (e.g., rounded) tip. As a result, when engaged with the contact pad 646, the voltage pin 653′ will extend into the opening and, thus, below the exterior plane of contact pad 646 without extending through the contact pad 646. The connector pins 653 may have the same physical dimensions (e.g., length, shape, cross-sectional area) or, in the alternative, different physical dimensions. Although the voltage pin 653′ is the only connector pin 653 illustrated as being engaged with the surface discontinuity 650 of the contact pad 646, it should be understood that other combinations are possible. For instance, one or both of the current pins 653″ may be additionally or alternatively engaged with corresponding surface discontinuities 650 in the contact pad 646.

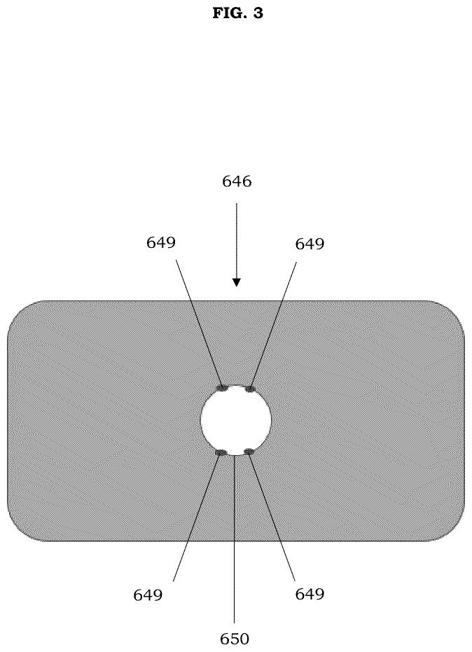

FIG. 3 is a schematic, plan view of the pin contact locations for a surface discontinuity of a contact pad of a power-receiving unit according to an example embodiment. Referring to FIG. 3, the connector pins 653 and the contact pad 646 may be configured such that an engagement force between at least one connector pin 653 and the contact pad 646 may be focused on a relatively small surface area via the presence of a surface discontinuity 650 in the contact pad 646. For instance, when a connector pin 653 has a quadrilateral cross-section, the connector pin 653 may engage at four locations with an opening provided as a surface discontinuity 650 in the contact pad 646. The four pin contact locations/points 649 shown in FIG. 3 may coincide with the locations/points where the four corners of the tip of the connector pin 653 in FIGS. 1-2 impinges with the rim/edge of the opening. Because the engagement force is focused on the relatively small area of the four locations, the likelihood of penetrating (e.g., mechanically and/or electrically) the outer layer of metal oxide and electrically connecting with the underlying metal is increased. Consequently, the rim/edge of the opening in the contact pad 646 may exhibit visual evidence of impingement from the connector pin 653 (e.g., dents at the pin contact locations 649) when the connector pin 653 is disengaged from the contact pad 646. It should be understood that the number of pin contact locations 649 in an opening in the contact pad 646 may vary based on the cross-sectional shape of a connector pin 653. In particular, when the cross-sectional shape of a connector pin 653 is a quadrilateral (e.g., rectangle, square), the number of pin contact locations 649 in a corresponding opening may be four. However, when the cross-sectional shape of a connector pin 653 is a triangle, the number of pin contact locations 649 in a corresponding opening may be three. In other instances, if the connector pin 653 has a hexagonal cross-sectional shape, then the number of pin contact locations 649 in a corresponding opening may be six.

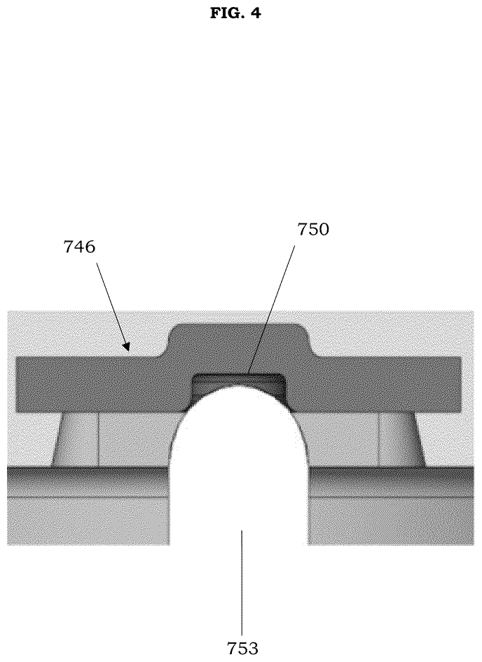

FIG. 4 is a schematic, cross-sectional view of a connector pin of a power-supplying unit as engaged with a surface discontinuity of a contact pad of a power-receiving unit according to an example embodiment. Referring to FIG. 4, the contact pad 746 may be provided with a recess (e.g., dimple) as the surface discontinuity 750 for enhancing an electrical connection with the connector pin 753. The recess in the contact pad 746 may be formed with a punching/stamping process (e.g., recess punching process), wherein the punch has a cross-sectional area corresponding to the desired shape and size of the recess. For instance, a punch with a cylindrical form and circular cross-section may be used to create a circular recess in the contact pad 746 as the surface discontinuity 750. As a result of the punching/stamping process, the section of the contact pad 746 corresponding to the recess is displaced/forced outward from the main plane of the contact pad 746. The rim/edge of the recess may also be slightly rounded from the punching/stamping process so as to have an outer diameter that is slightly larger than an inner diameter at an interior/base of the recess. It should be understood that a recess in the contact pad 746 may also be created with a process other than punching/stamping. For instance, a recess may also be created in the contact pad 746 via drilling.

In FIG. 4, the focused engagement between a connector pin 753 and the recess in the contact pad 746 may be as described in connection with FIG. 3. In particular, the connector pin 753 may be larger than the recess in at least one dimension. For instance, in an example embodiment, a width of the connector pin 753 is larger than a diameter of the recess. Notably, a width of the connector pin 753 and a degree of tapering/curvature of the tip is such that the connector pin 753 impinges upon the rim/edge of the recess in the contact pad 746 without touching the base of the recess. As a result, the force associated with the engagement of the connector pin 753 to the contact pad 746 can be focused and more fully translated to the contact locations on the rim/edge of the recess. The focusing of the engagement force will increase the likelihood of the connector pin 753 penetrating the outer layer of metal oxide via the contact locations on the rim/edge of the recess and directly contacting the underlying metal for a more reliable electrical connection. While only one recess and corresponding connector pin 753 are illustrated in FIG. 4, it should be understood that example embodiments are not limited thereto, and additional recesses and corresponding connector pins 753 may be provided in other instances.

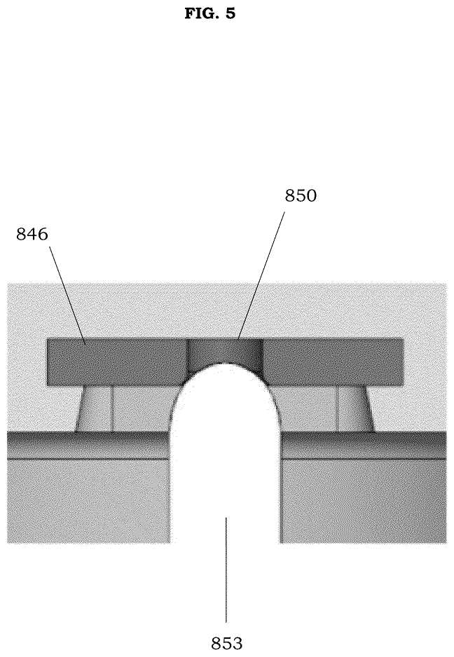

FIG. 5 is a schematic, cross-sectional view of a connector pin of a power-supplying unit as engaged with a surface discontinuity of a contact pad of a power-receiving unit according to another example embodiment. Referring to FIG. 5, the contact pad 846 may be provided with a hole (e.g., through hole) as the surface discontinuity 850 for enhancing an electrical connection with the connector pin 853. The hole in the contact pad 846 may be formed with a punching/stamping process (e.g., hole punching process), wherein the punch has a cross-sectional area corresponding to the desired shape and size of the hole. For instance, a punch with a cylindrical form and circular cross-section may be used to create a circular hole in the contact pad 846 as the surface discontinuity 850. It should be understood that a hole in the contact pad 846 may also be created with a process other than punching/stamping. For instance, a hole may also be created in the contact pad 846 via drilling.

In FIG. 5, the focused engagement between a connector pin 853 and the hole in the contact pad 846 may be as described in connection with FIG. 3. In particular, the connector pin 853 may be larger than the hole in at least one dimension. For instance, in an example embodiment, a width of the connector pin 853 is larger than a diameter of the hole. Notably, a width of the connector pin 853 and a degree of tapering/curvature of the tip is such that the connector pin 853 impinges upon the rim/edge of the hole in the contact pad 846 without extending through the hole (e.g., without touching the adjacent material/component on the opposite side of the contact pad 846). As a result, the force associated with the engagement of the connector pin 853 to the contact pad 846 can be focused and more fully translated to the contact locations on the rim/edge of the hole. The focusing of the engagement force will increase the likelihood of the connector pin 853 penetrating the outer layer of metal oxide via the contact locations on the rim/edge of the hole and directly contacting the underlying metal for a more reliable electrical connection. While only one hole and corresponding connector pin 853 are illustrated in FIG. 5, it should be understood that example embodiments are not limited thereto, and additional holes and corresponding connector pins 853 may be provided in other instances.

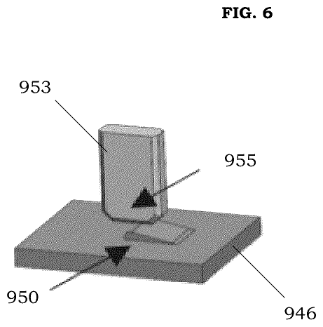

FIG. 6 is a schematic, perspective view of a connector pin of a power-supplying unit configured for engagement with a surface discontinuity of a contact pad of a power-receiving unit according to an example embodiment. Referring to FIG. 6, a shear surface approach may be utilized, wherein the contact pad 946 is provided with a chamfer (e.g., R0.1 chamfer) as the surface discontinuity 950 for enhancing an electrical connection with the connector pin 953. The contact pad 946 may be machined to form the chamfer, although example embodiments are not limited thereto. The connector pin 953 may be provided with a flat contact tip 955 to help focus the engagement force on the chamfer, thus increasing the likelihood of the connector pin 953 penetrating the outer layer of metal oxide and directly contacting the underlying metal for a more reliable electrical connection. While only one chamfer and corresponding connector pin 953 are illustrated in FIG. 6, it should be understood that example embodiments are not limited thereto, and additional chamfers and corresponding connector pins 953 may be provided in other instances.

The electrical current received by the power-receiving unit may be used to energize, activate, run, or otherwise operate an electrically-powered component, arrangement, or system therein to produce a desired result. In an example embodiment, the electrically-powered component, arrangement, or system may include a heater, light-emitting element (e.g., LED), sensor, motor, and/or display. It should be understood that the various examples of electrically-powered component, arrangement, or system within the power-receiving unit are not exhaustive and are intended to encompass further embodiments known by those of ordinary skill in the art.

In an example embodiment, a power-receiving unit may include a heater that generates heat when an electrical current is received from a power-supplying unit. The heater may include a first end section, an intermediate section, and a second end section. The first end section and the second end section may include external segments of the heater configured to establish an electrical connection with the power-supplying unit (e.g., contact pads for receiving an electrical current from the power-supplying unit). The intermediate section may be a segment (e.g., internal segment) of the heater configured to undergo an increase in temperature so as to generate heat.

A sheet material may be cut or otherwise processed (e.g., stamping, electrochemical etching, die cutting, laser cutting) to produce the heater. In such an instance, the heater will have an integral, continuous form. The sheet material may be formed of one or more conductors configured to undergo Joule heating (which is also known as ohmic/resistive heating). Suitable conductors for the sheet material include an iron-based alloy (e.g., stainless steel, iron aluminides), a nickel-based alloy (e.g., nichrome), and/or a ceramic (e.g., ceramic coated with metal). For instance, the stainless steel may be a type known in the art as SS316L, although example embodiments are not limited thereto. The sheet material may have a thickness of about 0.10 mm-0.30 mm (e.g., 0.15 mm-0.25 mm). The heater may have a resistance between 0.5 Ohm-2.5 Ohms (e.g., 1.0 Ohm-2.0 Ohms).

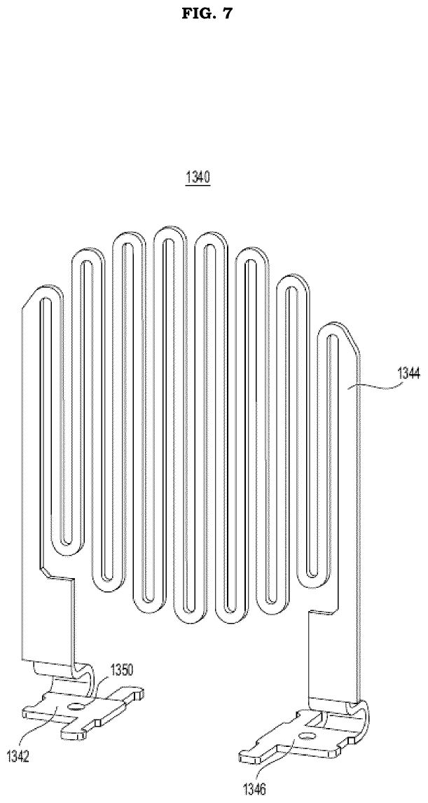

FIG. 7 is an isolated view of a heater with end sections as contact pads having at least one surface discontinuity according to an example embodiment. Referring to FIG. 7, a heater 1340 includes a first end section 1342, an intermediate section 1344, and a second end section 1346. The intermediate section 1344 of the heater 1340 may have a planar and winding form resembling a compressed oscillation or zigzag with a plurality of parallel segments (e.g., eight to sixteen parallel segments). In an example embodiment, the two outermost parallel segments of the intermediate section 1344 may be wider than the inner parallel segments (e.g., 0.60 mm versus 0.30 mm) for thermal relief and mechanical stiffening. In addition to the example shown, it should be understood that other forms for the intermediate section 1344 of the heater 1340 are also possible (e.g., spiral form, flower-like form).

The terminus of each of the first end section 1342 and the second end section 1346 may be oriented orthogonally to the plane of the intermediate section 1344. Each of the first end section 1342 and the second end section 1346 may also include segments having a sideways J-shape. Furthermore, each of the first end section 1342 and the second end section 1346 may include opposing finger/claw-like structures. The finger/claw-like structures may serve as locating features for manufacturing equipment (e.g., overmolding tool). As a result, the first end section 1342 and the second end section 1346 may be embedded relatively securely within a body or housing of a power-receiving unit while providing a pair of electrical contact surfaces.

Regarding the first end section 1342 and the second end section 1346, which may also be referred to as the contact pads, a surface discontinuity 1350 in a form of an opening may be provided in each of the first end section 1342 and the second end section 1346. The surface discontinuity 1350 may be pre-formed in each of the first end section 1342 and the second end section 1346 prior to the assembly of the power-receiving unit, although example embodiments are not limited thereto.

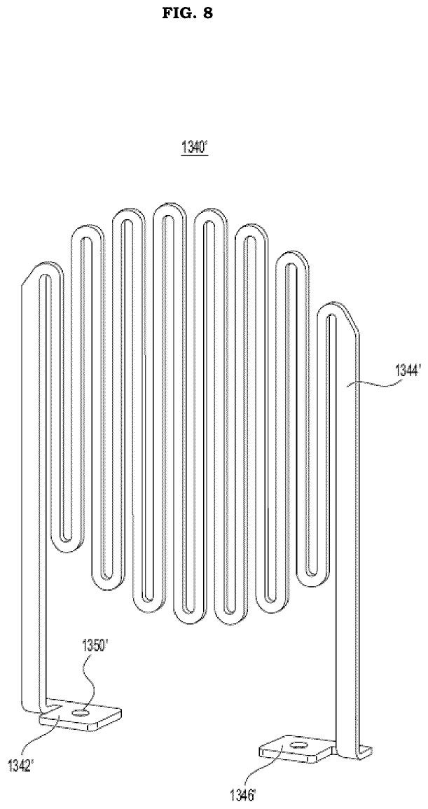

FIG. 8 is an isolated view of a heater with end sections as contact pads having at least one surface discontinuity according to another example embodiment. Referring to FIG. 8, the heater 1340′ includes a first end section 1342′, an intermediate section 1344′, and a second end section 1346′. The first end section 1342′, the intermediate section 1344′, and the second end section 1346′ of the heater 1340′ may be the same as described in connection with the first end section 1342, the intermediate section 1344, and the second end section 1346, respectively, of the heater 1340 unless indicated otherwise. For instance, with regard to differences, the transition from the intermediate section 1344′ to the first end section 1342′ and the second end section 1346′ may involve little or no dimension change (e.g., uniform width versus the wider, thermal relief/lower resistance sections in FIG. 7). In addition, the first end section 1342′ and the second end section 1346′ may each include a simplified tab as the anchor structure and the electrical contact structure.

Regarding the first end section 1342′ and the second end section 1346′, which may also be referred to as the contact pads, a surface discontinuity 1350′ in a form of an opening may be provided in each of the first end section 1342′ and the second end section 1346′. The surface discontinuity 1350′ may be pre-formed in each of the first end section 1342′ and the second end section 1346′ prior to the assembly of the power-receiving unit, although example embodiments are not limited thereto.

In at least some example embodiments and as noted supra, the power-supplying unit may include a power source and a processing or control circuitry. The control circuitry may be hardware including logic circuits; a hardware/software combination such as a processor executing software; or a combination thereof. For example, the control circuitry may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

It should be understood that the shape of the battery (or batteries) for the power source may vary. For example, the battery may be cylindrical, prismatic, disc-shaped, a pouch battery, or any other variation of battery shape known in the art. Additionally, it should be understood that the battery may be any of a variety of types. For example, in one embodiment, the battery may be a rechargeable battery (e.g., lithium-ion). In another embodiment, the battery may be a non-rechargeable battery (e.g., alkaline). In yet another embodiment, the battery may include silver oxide, carbon zinc, cadmium, nickel, or any another material known in the art. Furthermore, the battery may include a primary cell and/or a secondary cell. It will be understood by those of ordinary skill in the art that various changes in form and details of the battery may be made without departing from the spirit and the scope of the invention.

While some example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims. For example, while aspects of the invention have been described with respect to providing improved electrical contact in the presence of an oxide layer, it should be understood that the example embodiments are also applicable and provide improved electrical contact regardless of the presence of an oxide layer (e.g., in the absence of an oxide layer).

Although described with reference to specific examples and drawings, modifications, additions and substitutions of example embodiments may be variously made according to the description by those of ordinary skill in the art. For example, the described techniques may be performed in an order different with that of the methods described, and/or elements such as the described system, architecture, devices, circuit, and the like, may be connected or combined to be different from the above-described methods, or results may be appropriately achieved by other elements or equivalents.

1. An electrical contact pad, comprising:
a conductive component including at least one surface discontinuity configured to enhance an electrical connection therewith.

2. The electrical contact pad of claim 1, wherein the conductive component has a planar section with the at least one surface discontinuity.

3. The electrical contact pad of claim 1, wherein the at least one surface discontinuity includes one or more structurally-vulnerable portions configured to serve as focused points of contact during an establishment of the electrical connection.

4. The electrical contact pad of claim 3, wherein the one or more structurally-vulnerable portions are configured to physically yield during the establishment of the electrical connection.

5. The electrical contact pad of claim 1, wherein the at least one surface discontinuity includes one or more edges.

6. The electrical contact pad of claim 1, wherein the at least one surface discontinuity includes a rim.

7. The electrical contact pad of claim 1, wherein the at least one surface discontinuity is a machined portion of the conductive component that is configured to receive an electric current.

8. The electrical contact pad of claim 1, wherein the at least one surface discontinuity is an opening in a surface of the conductive component.

9. The electrical contact pad of claim 8, wherein the opening is a recess.

10. The electrical contact pad of claim 9, wherein the recess is a dimple.

11. The electrical contact pad of claim 8, wherein the opening is a through hole in the conductive component.

12. The electrical contact pad of claim 8, wherein the opening has a shape of a circle.

13. The electrical contact pad of claim 12, wherein the circle has a diameter between 0.3 mm to 0.5 mm.

14. The electrical contact pad of claim 1, wherein the at least one surface discontinuity is a chamfer on a surface of the conductive component.

15. A heater comprising:
a first end section;
an intermediate section; and
a second end section, the first end section and the second end section each having at least one surface discontinuity configured to enhance an electrical connection therewith.

16. The heater of claim 15, wherein the at least one surface discontinuity includes one or more structurally-vulnerable portions configured to serve as focused points of contact during an establishment of the electrical connection.

17. A power-receiving unit, comprising:
a pair of electrical contact pads each having at least one surface discontinuity configured to enhance an electrical connection therewith.

18. The power-receiving unit of claim 17, wherein the pair of electrical contact pads are part of an exterior surface of the power-receiving unit.

19. An electronic device comprising:
a power-receiving unit including a pair of electrical contact pads each having at least one surface discontinuity; and
a power-supplying unit including connector pins configured to engage with the at least one surface discontinuity of each of the pair of electrical contact pads so as to establish an electrical connection with the power-receiving unit.

20. The electronic device of claim 19, wherein the connector pins include voltage pins configured to engage with the at least one surface discontinuity of each of the pair of electrical contact pads.
